(19) United States
(12) Patent Application Publication
(10) Pub. No.: US 2003/0225643 A1
(43) Pub. Date: Dec. 4, 2003

(54) System, method, and lease structure for cross-border financing

(75) Inventor: Vern V. Kakoschke, Oakville (CA)

Correspondence Address: FOLEY AND LARDNER, SUITE 500, 3000 K STREET NW, WASHINGTON, DC, 20007, US

(73) Assignee: ALLCO (CANADA) FINANCE INC.

(21) Appl. No.: 10/160,294

(22) Filed: Jun. 4, 2002

(30) Foreign Application Priority Data
Jun. 3, 2002 (CA) 2,388,683

(51) Int. Cl. G06F 17/60

(52) U.S. Cl. 705/35

(57) ABSTRACT

System, method, and lease structure for cross-border financing are disclosed. The method uses qualified technological equipment, software, and rights in the software owned by a first party resident in a first jurisdiction, comprising assessing the fair market value of the assets, the first party transferring the rights in the assets to a special purpose entity in a second jurisdiction set up by a second party; and the special purpose entity leasing the assets to the first party under a reverse lease. In a variation, the qualified technological equipment is dealt with in a separate transaction from the software involving a sale or lease of the rights of the first party followed by a reverse lease.

### TECHNICAL FIELD OF THE INVENTION

The present invention relates to a system, method, and a lease structure directed to financing assets located in one jurisdiction in the leasing market of another jurisdiction.

### BACKGROUND OF THE INVENTION

Corporations and other entities (including governmental entities) that own and operate large-ticket equipment, such as transportation assets (aircraft or rolling stock) or other major assets (the “Leased Assets) have for many years financed those assets by leasing the same from financial institutions. The advantages of leasing rather than owning these assets included off-balance sheet accounting treatment and lower cost of financing offered by leasing companies when compared to more traditional forms of financing. Many of these leasing companies are based in the United States and in order to access the US leasing market, it became necessary for non-US lessees to develop cross border lease structures that minimized the tax burden on the transaction and preserved the economic benefit of the same.

In order for a cross border lease to be attractive to a non-US lessee (user of equipment), including a Canadian lessee, the lease payments made by the lessee to the non-resident lessor must not attract withholding tax in the lessee's jurisdiction. The Canadian airline industry lobbied the federal finance authorities and obtained a special exemption from withholding tax for lease payments in respect of aircraft. Lease payments in respect of other assets, however, must be carefully structured so as not to run afoul of withholding tax rules.

One cross border lease structure that became popular in the 1990s was the use of a hybrid Canadian entity as the lessor. The US party wishing to lease assets to a Canadian lessee would establish an unlimited liability company (“ULC”), typically in the province of Nova Scotia. The ULC would be capitalized with limited recourse debt provided by a lender and equity provided by the US party, the Investor. The ULC would purchase the asset in question and immediately lease it back to the Canadian lessee. The ULC, as a hybrid entity, would be viewed under Canadian law as a separate legal entity and under US tax law as a flow through entity. This structure allows a US lessor to offer Canadian lessees relatively advantageous lease rates; although not as favourable as the lease rates it could offer the lessee if the lease were made directly from the Investor to the Canadian lessee.

The hybrid lease structure using a ULC is not, however, without its drawbacks. As a separate entity, the corporate existence of the ULC must be maintained for the duration of the lease and all relevant taxes on the ULC, including income tax, capital tax and sales tax, must be paid by the ULC. The repatriation of the Investor's return also attracts withholding tax (currently, 5%) on the dividends paid by the ULC to the Investor. The administrative burden of maintaining the ULC is also a factor that must be considered when deciding to set up such a hybrid lease structure.

In some cases, the Lessee may prefer not to part with the legal title to the Leased Assets when a sale/leaseback transaction is considered.

There is a need for a method, system, and lease structure which address the needs mentioned above and offers a more efficient structure that produces a better economic result for the lessee and investors.

### SUMMARY OF THE INVENTION

It is an object of this invention to open up a source of financing technological assets to corporations or other entities in Canada and provide a cheaper source of funds with a reduced tax burden and a lower risk profile in relation to past transactions involving a ULC to such corporations or other entities.

According to another aspect of this invention, a method, system, and lease structure are provided which substitutes a long-term head lease from the Lessee in lieu of an outright sale of the assets in question.

### BRIEF DESCRIPTION OF THE DRAWINGS

FIG. 1 illustrates a preferred embodiment of the invention in a transaction involving the bifurcated lease structure showing the hardware lease involving a Canadian Lessee and an investor in the US.

FIG. 2 illustrates a preferred embodiment of the invention in a transaction involving the bifurcated lease structure showing the software lease involving a Canadian Lessee and an investor in the US.

Similar references are used to denote similar components in the drawings.

### DETAILED DESCRIPTION OF THE INVENTION

The methods, systems, and lease structure described below involve a leveraged lease financing of the Leased Assets with the Investor being in one jurisdiction, preferably the United States, and the Lessee being the user or operator of the Leased Assets in another jurisdiction, preferably Canada. The Leased Assets preferably, but not necessarily, fall within the definition of “Qualified Technological Equipment” (“QTE”) under the US Tax Code. This would normally include equipment such as telephone switching equipment, computers, mail sorting equipment, flight simulators, and air traffic control equipment. An internationally recognized firm of appraisers is customarily retained to appraise the equipment and confirm that it does qualify as QTE. Software to be used in conjunction with some or all of the QTE may also be involved as part of the Leased Assets.

HEAD LEASE. The first step in the structure is to transfer ownership of the Leased Assets for the purposes of U.S. tax law to a special purpose entity (the “SPE”) set up by an Investor, including a transfer of copyright in the software or other intellectual property, at fair market value (as confirmed by an appraisal). This transfer of ownership is accomplished in one of two ways. The Lessee may sell the Leased Assets to the SPE; alternatively, a lease (the “Head Lease”) from the Lessee to the SPE (the “Sublessor”) for a term greater than the expected remaining useful life of the Leased Assets may be used. The Head Lease may be prepaid at the outset by the SPE such that the Lessee would receive a prepayment of rent approximately equal to the fair market value of the Leased Assets. A term of 100 years may be appropriate, possibly less depending on the particular types of Leased Assets. Typically, the Head Lease is treated as a true sale for U.S. tax purposes by the Investor.

The discussion that follows assumes that tax ownership for US purposes is transferred to the Sublessor under a Head Lease, i.e. the lease/leaseback structure. However, the Leased Assets may have been transferred by a sale. For notational convenience, the purchasing party is still denoted as the Sublessor and a reverse lease back to the Lessee the “Sublease”.

CAPITALIZATION OF THE SPE. In a preferred embodiment, the SPE as the Sublessor is capitalized with a combination of debt and equity. A certain amount, preferably about 80%, of the Equipment Value is provided by one or more lenders (the “Lender”) under one or more loans (the “Loan”) to the Sublessor which is recourse only to the Head Lease. The Investor provides the balance of the Equipment Value (preferably about 20%) to the Sublessor as its equity investment. The Sublessor will use these funds (debt and equity) to prepay the Head Lease at closing (or to pay for the purchase of the Leased Assets from the Lessee).

The Lender's security preferably includes a first ranking security interest in the Sublessor's leasehold interest in the Equipment and its rights under the Head Lease. The Lender's security preferably also includes a first ranking security assignment in the Debt PUA described below.

OWNERSHIP OF THE SPE. The SPE will typically be owned by one or more special purpose entities, established typically by the Investor in the US. In the preferred embodiment, the Investor and the SPE will not have a permanent establishment in Canada. The SPE will preferably be an unlimited liability corporation (“ULC”), typically established in the Canadian province of Nova Scotia, having a registered office in Nova Scotia, but not carrying on business in Canada except the province of Alberta.

SUBLEASE. The Sublessor will then lease (the “Sublease”) the Leased Assets to the Lessee for a fixed term that will typically be approximately 80 percent of the remaining useful life of the Leased Assets. The implicit lease rate would typically be less than the interest rate at which the Leased Assets could otherwise be financed in the jurisdiction of the Lessee. Under the terms of the Sublease, the Lessee will typically have a fixed price option to purchase the leasehold rights in the Leased Assets (the “Purchase Option”) at a certain point. If the Purchase Option is not exercised, the Sublease will continue until the end of its term but with the Lessee typically being required to obtain certain residual value insurance regarding the end of term value of the Leased Assets or arrange a service contract in respect of the Leased Assets. The Lessee will usually hedge its currency and interest rate exposure resulting from its obligations under the Sublease using derivative financial instruments, including the Equity Defeasance and the Debt PUA described below.

DEFEASANCE. If the Lessee does not have an immediate use for the proceeds of the financing, it may prefer to defease its obligations under the Sublease by making arrangements to have its payment obligations settled in advance. The rent and Purchase Option price payable under the Sublease may be defeased by the Lessee making the following arrangements. An amount corresponding to each Loan payment shall be paid to the Sublessor from the proceeds of the Debt PUA. The Sublessor shall use this portion of each rent payment to service repayments under the Loan. The balance of the rent and Purchase Option price will be serviced by the Equity Defeasance. In summary, the Lessee would use the prepayment received by it under the Head Lease as follows in one possible embodiment:

| | |
|---|---|
| Purchase price for the Equity Defeasance | 12% |
| Payment to Debt PUA Counterparty to purchase Debt PUA | 80% |
| Estimated Net Present Value Benefit to Lessee | 8% |
| | 100% |

DEBT PUA. Simultaneously with the closing of the Head Lease and Sublease, the Lessee will enter into one or more payment undertaking agreements (the “Debt PUA”) with the Debt PUA Counterparty, being one or more major financial institutions that may be affiliated with the Lender. The Debt PUA will preferably require the Lessee to make a one-time payment to the Debt PUA Counterparty in exchange for a series of unconditional payments over time. The payments made to or on behalf of the Lessee under the Debt PUA will enable the Lessee to pay all of the lease payment obligations associated with the Loan under the Sublease. The Debt PUA will be pledged to the Lender by the Sublessor in order to secure the Sublessor's obligations to the Lender under the Loan.

EQUITY DEFEASANCE. At closing of the Head Lease and Sublease, the Lessee will pay an amount equal to a fixed percentage of the Equipment Value, shown as 12 percent in the embodiment referred to earlier, to purchase certain financial instruments (for example, zero coupon bonds issued by a government entity) or other highly rated securities which will produce a cash flow matching the payment obligations under the Sublease that have already not been met by the Debt PUA. This investment (the “Equity Defeasance”) will grow over time and will mature in amounts sufficient to pay for the non-debt related payments under the Sublease and the equity portion of the Purchase Option price.

Although the above discloses the use of both Debt PUA and Equity Defeasance in a transaction, this invention includes variations where only one of the two mechanisms are used by a Lessee for paying the lease payments.

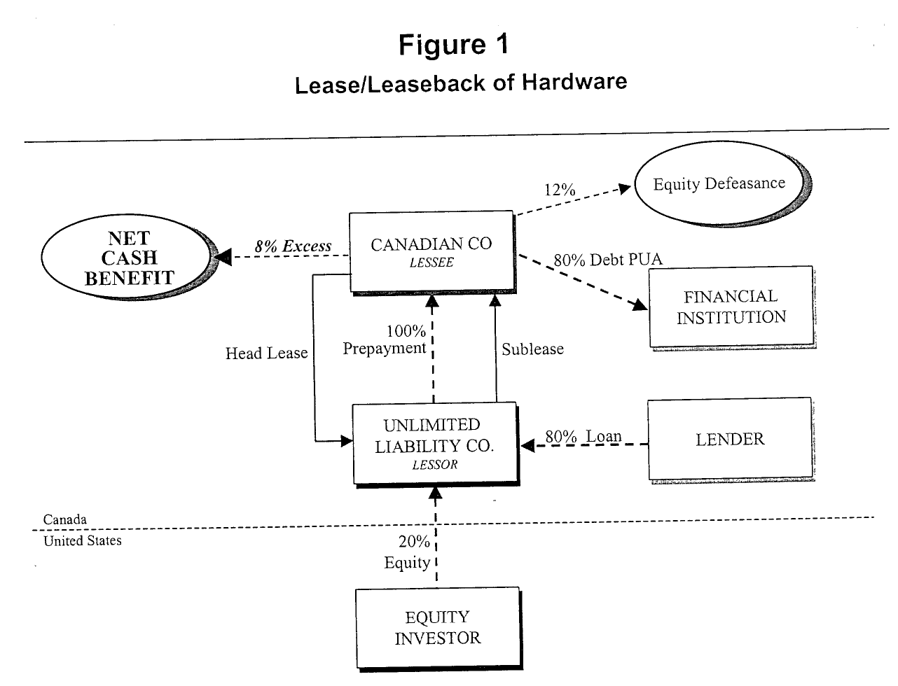

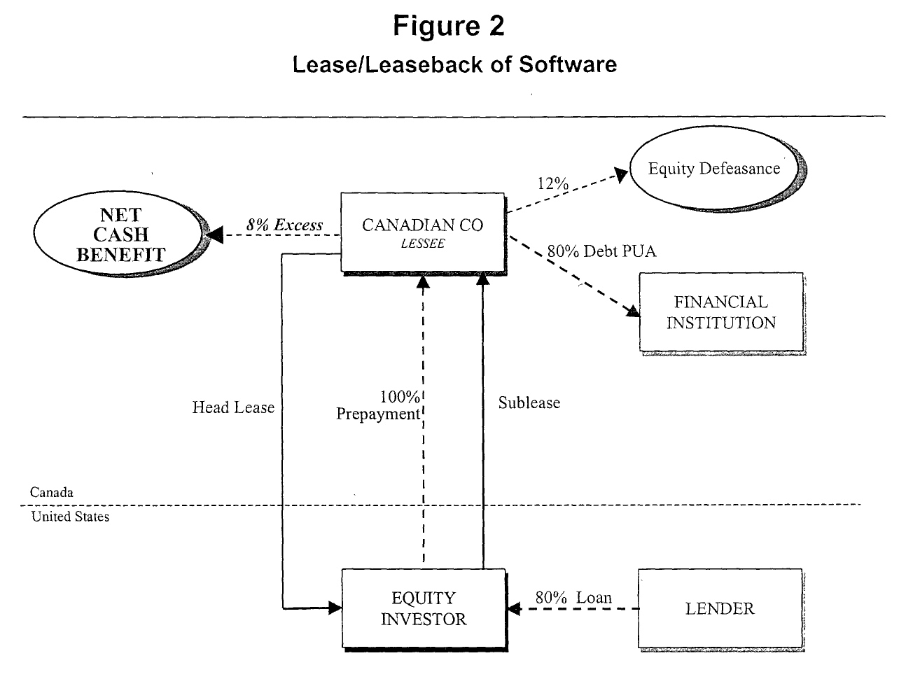

BIFURCATED STRUCTURE. Where the Leased Assets include a significant proportion of software in addition to QTE, the foregoing transaction would be bifurcated into a lease/leaseback of software and a lease/leaseback of hardware. FIGS. 1 and 2 illustrate the bifurcated structure showing hardware and software leasing separately using the numeral figures of the embodiment referred to earlier. The software component would be leased directly to the Investor (or a special purpose entity owned by the Investor, or a trust under which the Investor is the beneficiary) under a Head Lease and then leased back to the Lessee (the “Software Lease”). The payments made under the Software Lease would be structured to fall within the protection afforded by Section 3 of Article XII of the United States-Canada Income Tax Treaty. The hardware component would be leased to the ULC as described above in the section OWNERSHIP OF THE SPE and then leased back to the Lessee (the “Hardware Lease”). The Investor would treat the Hardware Lease and the Software Lease would in substance a single transaction.

The Hardware Lease above would typically be cross-defaulted to the Software Lease such that default under one would immediately trigger default under the other. The bifurcated structure would result in significant cost savings as well as reduced transaction risk.

Further preferred embodiments of this invention are a computer-assisted method and system for the bifurcated lease structure discussed above in calculating the maximum Net Present Value (“NPV”) Benefit for the Lessee. Input is first received from the user of the computer software concerning the bifurcated lease structure. An optimal set of outputs is then derived and displayed, which outputs will achieve stated maximum (or minimum) objectives. This method provide Lessors and Lessees with the best possible economics for any given QTE lease from one jurisdiction, preferably the US, into another jurisdiction, preferably Canada. The software component of this method may be implemented using the software system ABC™, augmented with macros. The macros are designed so that the economic position of the ULC is optimized at the same time as the economic return to the Investor is maximized. The macros contain constraints that reflect the current accounting and tax rules applicable to the transaction in both the US and Canada. The macros will generate a rent profile for the Sublease that produces accounting income for the Investor while minimizing the tax burden on the Investor.

The foregoing is only considered as illustrative of the principles of the invention. Further, since numerous modifications and changes will readily occur to those skilled in the art, it is not desired to limit the invention to the exact construction and applications shown and described, and accordingly, all suitable modifications and equivalents may be resorted to, falling within the scope of the invention and the appended claims and their equivalents.

What is claimed is:

1. A system for facilitating a cross-border finance transaction, comprising:
qualified technological equipment owned by a first party residing in a first jurisdiction; and
software for use in conjunction with the qualified technological equipment owned by the first party;
wherein:
the fair market value of the qualified technological equipment and the software is assessed;
the first party transfers rights in the qualified technological equipment to a special purpose entity,
the special purpose entity leases rights of use and operation of the qualified technological equipment under a hardware lease to the first party for a first term;
the first party transfers rights to the software to a second party residing in a second jurisdiction external to the first jurisdiction; and
the second party leases rights of use and operation of the software to the first party under a software lease for a second term.

2. The system of claim 1, wherein the special purpose entity is an unlimited liability corporation established and having a registered office in the province of Nova Scotia in Canada, and does not carry on business in Canada except the province of Alberta, and the first jurisdiction is Canada.

3. The system of claim 1, wherein the rights in the qualified technological equipment are transferred by the first party to the special purpose entity under an outright sale of the ownership rights in the qualified technological equipment, at fair market value.

4. The system of claim 1, wherein the rights in the qualified technological equipment are transferred by the first party to the special purpose entity under a head lease of the qualified technological equipment for a term greater than the expected remaining useful life of the qualified technological equipment.

5. The system of claim 1, wherein the implicit lease rate under the hardware lease is less than the interest rate at which the qualified technological equipment could otherwise be financed in the jurisdiction of the first party.

6. The system of claim 5, wherein the head lease is prepaid by the special purpose entity such that the first party receives a prepayment of rent from the special purpose entity approximately equal to the fair market value of the qualified technological equipment.

7. The system of claim 5, wherein the special purpose entity obtains the funds for the prepayment of rent from a financing entity under a debt and equity finance arrangement.

8. The system of claim 1, wherein the first party enters into a debt payment undertaking agreement for meeting payment obligations under any one or both of the hardware and software leases.

9. The system of claim 1, wherein the first party purchases a financial instrument for meeting payment obligations under any one or both of the hardware and software leases.

10. The system of claim 1, wherein the rights in the software are transferred by the first party under an outright sale of the ownership rights in the software or a lease, to the second party, a special purpose entity owned by the second party or a trust under which the second party is the beneficiary.

11. The system of claim 1, wherein the second party is the second party personally, a special purpose entity owned by the second party, or a trust under which the second party is the beneficiary.

12. The system of claim 1, wherein the qualified technological equipment comprises one or more items chosen from the group comprising telephone switching equipment, computers, mail sorting equipment, flight simulators, and air traffic control equipment.

13. The system of claim 1, wherein the payments under the software lease fall within section 3 of Article XII of the United States-Canada Income Tax Treaty.

14. A bifurcated leasing structure for financing qualified technological equipment and software for use in conjunction with the qualified technological equipment, being Leased Assets, comprising:
(i) a sale or head hardware Lease of the qualified technological equipment from a first party resident in Canada to a special purpose entity established under the laws of the province of Nova Scotia, the special purpose entity having a registered office in Nova Scotia but does not carry on business in Canada except in the province of Alberta, the lease being prepaid at the outset by the special purpose entity such that the first party would receive a prepayment of rent approximately equal to the fair market value of the Leased Assets;
(ii) a hardware lease of the qualified technological equipment from the special purpose entity to the first party at an implicit lease rate that is less than the interest rate at which the Leased Assets could otherwise be financed in Canada;
(iii) a sale or head software Lease of the software from the first party to a second party resident in the United States of America or a trust under which the second party is the beneficiary; and
(iv) a software lease of the qualified technological equipment from the second party back to the first party at an implicit lease rate that is less than the interest rate at which the Leased Assets could otherwise be financed in Canada.

15. The leasing structure of claim 14, wherein the qualified technological equipment comprises one or more items chosen from the group comprising telephone switching equipment, computers, mail sorting equipment, flight simulators, and air traffic control equipment.

16. The leasing structure of claim 14, wherein the payments under the software lease fall within section 3 of Article XII of the United States-Canada Income Tax Treaty.

17. A method of financing using qualified technological equipment, software for use in conjunction with the qualified technological equipment, and rights in the software, being Leased Assets owned by a first party resident in a first jurisdiction, comprising the steps of:
(i) Assessing the fair market value of the Leased Assets;
(ii) The first party transferring the rights in the Leased Assets to a special purpose entity in a second jurisdiction set up by a second party; and
(iii) The special purpose entity leasing the Leased Assets to the first party under a reverse lease at an implicit lease rate that is less than the interest rate at which the Leased Assets could otherwise be financed in the jurisdiction of the first party;
wherein the transfer of the rights in the Leased Assets from the first party to the special purpose entity is accomplished either by an outright sale of the Leased Assets at fair market value or by a head lease for a term greater than the expected remaining useful life of the Leased Assets.

18. The method of claim 17, wherein the special purpose entity is an unlimited liability corporation established in the province of Nova Scotia in Canada, has a registered office in Nova Scotia, and does not carry on business in Canada except the province of Alberta, and the first jurisdiction is Canada.

19. The method of claim 17, wherein the implicit lease rate under the reverse lease is less than the interest rate at which the qualified technological equipment could otherwise be financed in the jurisdiction of the first party.

20. The method of claim 19, wherein the first party transfers the rights in the Leased Assets by a head lease, the head lease being prepaid by the second party or the special purpose entity such that the first party receives a prepayment of rent approximately equal to the fair market value of the qualified technological equipment.

21. The method of claim 20, wherein the second party or special purpose entity obtains the funds for the prepayment of rent from a financing entity under a debt and equity finance arrangement.

22. The method of claim 17, wherein the first party enters into a debt payment undertaking agreement for meeting payment obligations under any one or both of the hardware and software leases.

23. The method of claim 17, wherein the first party purchases a financial instrument for meeting payment obligations under any one or both of the hardware and software leases.

24. The method of claim 17, wherein the qualified technological equipment comprises one or more items chosen from the group comprising telephone switching equipment, computers, mail sorting equipment, flight simulators, and air traffic control equipment.

25. A system facilitating a cross-border finance transaction, comprising:
qualified technological equipment, and
software for use in conjunction with the qualified technological equipment, and
rights in the software,
being Leased Assets owned by a first party resident in a first jurisdiction, wherein:
(i) the fair market value of the Leased Assets is assessed;
(ii) the first party transfers the rights in the Leased Assets to a special purpose entity by an outright sale of the Leased Assets at the fair market value or by a head lease for a term greater than the expected remaining useful life of the Leased Assets; and
(iii) The special purpose entity leases the Leased Assets to the first party under a reverse lease.

26. The system of claim 25, wherein the special purpose entity is an unlimited liability corporation resident in the province of Nova Scotia in Canada, has a registered office in Nova Scotia, and does not carry on business in Canada except the province of Alberta, and the first jurisdiction is Canada.

27. The system of claim 25, wherein the implicit lease rate under the reverse lease is less than the interest rate at which the qualified technological equipment could otherwise be financed in the first jurisdiction.

28. The system of claim 25, wherein the first party transfers the rights in the Leased Assets by a head lease, the head lease being prepaid by the special purpose entity such that the first party receives a prepayment of rent approximately equal to the fair market value of the qualified technological equipment.

29. The system of claim 28, wherein the special purpose entity obtains the funds for the prepayment of rent under the reverse lease from a financing entity under a debt and equity finance arrangement.

30. The system of claim 25, wherein the first party enters into a debt payment undertaking agreement for meeting payment obligations under the reverse lease.

31. The system of claim 25, wherein the first party purchases a financial instrument for meeting payment obligations under the reverse lease.

32. The system of claim 25, wherein the qualified technological equipment comprises one or more items chosen from the group comprising telephone switching equipment, computers, mail sorting equipment, flight simulators, and air traffic control equipment.

33. A computer-assisted method for determining the optimal characteristics of a bifurcated lease structure defined in claim 14, comprising the steps of:
Receiving input concerning the bifurcated lease structure, the input comprising term, ratio of values of the qualified technological equipment to software; an appraised value of the qualified technological equipment and software;
Calculating the optimal characteristics of the bifurcated lease structure, comprising the net present value benefit to the first party and a rent profile under each of the software and hardware leases for maximizing the return on investment for the Investor while minimizing the financing cost to the Lessee; and
Displaying the optimal characteristics of the bifurcated lease structure.
